(19) United States
(12) Patent Application Publication
(10) Pub. No.: US 2026/0156489 A1
(43) Pub. Date: Jun. 4, 2026

(54) Optimized Broadcast Messaging Among Unmanned Aerial Vehicles

(71) Applicants: University of North Texas, Denton, TX (US); Unmanned Experts Inc., Denver, CO (US)

(72) Inventors: Keven GAMBOLD, Denver, CO (US); Shane NICOLL, Denver, CO (US); Batool DALLOUL, Denver, CO (US); Kamesh NAMUDURI, Denton, TX (US); Skyler HAWKINS, Denton, TX (US); Mathias KIDANE, Denton, TX (US)

(73) Assignees: University of North Texas, Denton, TX (US); Unmanned Experts Inc., Denver, CO (US)

(21) Appl. No.: 18/933,068

(22) Filed: Oct. 31, 2024

(51) Int. Cl. H04W 24/02; H04W 64/00; H04W 76/14; H04W 84/06

(52) U.S. Cl. CPC H04W 24/02; H04W 64/006; H04W 76/14; H04W 84/06

(57) ABSTRACT

The present disclosure is directed to techniques for optimizing broadcast messaging among unmanned aerial vehicles (UAVs). A transmitting UAV may determine, based at least in part on utilizing an onboard sensor, state information associated with movement of the transmitting UAV and a receiving UAV operating in the airspace; broadcast, to the receiving UAV and based at least in part on determining the state information, an optimized broadcast message including the state information; directly communicate, with the receiving UAV, coordination information to coordinate real-time movement of the transmitting UAV and the receiving UAV; and effect, based at least in part on the coordination information, movement of the transmitting UAV in the airspace in relation to movement of the receiving UAV in the airspace. Various other aspects are contemplated.

### GOVERNMENT STATEMENT

This invention was made with Government support under FAA 8679-22-P-0778 awarded by the United States Air Force AFWERX AGILITY PRIME. The Government has certain rights in the invention.

### FIELD OF DISCLOSURE

Aspects of the present disclosure generally relate to use of hardware and/or software for enabling communication among devices, and in particular to optimizing broadcast messaging among unmanned aerial vehicles (UAVs).

### BACKGROUND

An unmanned aerial vehicle (UAV) may be described as an electronically powered, aerial vehicle that does not carry a human pilot. A UAV may utilize aerodynamic forces to provide lift, and may fly based at least in part on utilizing onboard processors that execute commands received from a ground control station (GCS).

UAVs come in various shapes, sizes, and configurations, and have gained significant prominence across various sectors due to their versatility, cost-effectiveness, and technological advancements. Both military and civilian sectors utilize UAVs extensively. For instance, the military sector utilizes UAVs to conduct surveillance missions, reconnaissance missions, combat missions, and rescue operations. Similarly, civilian entities utilize UAVs for purposes such as recreational activities, search and rescue missions, delivery of goods, transportation, and infrastructure inspection.

### SUMMARY

In an aspect, the present disclosure contemplates a transmitting UAV operating in airspace, the transmitting UAV comprising: a processor; and a memory communicatively coupled to the processor, the processor and the memory being configured to: determine, based at least in part on utilizing an onboard sensor, state information associated with movement of the transmitting UAV and a receiving UAV operating in the airspace; broadcast, to the receiving UAV and based at least in part on determining the state information, an optimized broadcast message including the state information; directly communicate, with the receiving UAV, coordination information to coordinate real-time movement of the transmitting UAV and the receiving UAV; and effect movement of the transmitting UAV in the airspace in relation to movement of the receiving UAV in the airspace.

In one aspect, the present disclosure contemplates a method in a transmitting UAV operating in an airspace, the method comprising: determining, based at least in part on utilizing an onboard sensor, state information associated with movement of the transmitting UAV and a receiving UAV operating in the airspace; broadcasting, to the receiving UAV and based at least in part on determining the state information, an optimized broadcast message including the state information; directly communicating, with the receiving UAV, coordination information to coordinate real-time movement of the transmitting UAV and the receiving UAV; and effecting movement of the transmitting UAV in the airspace in relation to movement of the receiving UAV in the airspace.

In another aspect, the present disclosure contemplates a non-transitory computer-readable medium configured to store instructions, which when executed by a processor associated with a transmitting unmanned aerial vehicle (UAV) operating in airspace, configure the processor to: determine, based at least in part on utilizing an onboard sensor, state information associated with movement of the transmitting UAV and a receiving UAV operating in the airspace; broadcast, to the receiving UAV and based at least in part on determining the state information, an optimized broadcast message including the state information; directly communicate, with the receiving UAV, coordination information to coordinate real-time movement of the transmitting UAV and the receiving UAV; and effect movement of the transmitting UAV in the airspace in relation to movement of the receiving UAV in the airspace.

It is to be understood that both the foregoing general description and the following detailed description are exemplary and explanatory in nature and are intended to provide an understanding of the present disclosure without limiting the scope thereof. In that regard, additional aspects, features, and advantages of the present disclosure will be apparent to one skilled in the art from the following detailed description.

### BRIEF DESCRIPTION OF THE DRAWINGS

The accompanying drawings illustrate aspects of systems, devices, methods, and/or mediums disclosed herein and together with the description, serve to explain the principles of the present disclosure. Throughout this description, like elements, in whatever aspect described, refer to common elements wherever referred to and referenced by the same reference number. The characteristics, attributes, functions, interrelations ascribed to a particular element in one location apply to those elements when referred to by the same reference number in another location unless specifically stated otherwise.

The figures referenced below are drawn for ease of explanation of the basic teachings of the present disclosure; the extensions of the figures with respect to number, position, relationship, and dimensions of the parts to form the following aspects may be explained or may be within the skill of the art after the following description has been read and understood. Further, exact dimensions and dimensional proportions to conform to specific force, weight, strength, and similar requirements will likewise be within the skill of the art after the following description has been read and understood.

The following is a brief description of each figure used to describe the present disclosure, and thus, is being presented for illustrative purposes only and should not be limitative of the scope of the present disclosure.

FIG. 1 is an illustration of an example system associated with optimizing broadcast messaging among UAVs, according to various aspects of the present disclosure.

FIG. 2 is an illustration of an example flow associated with optimizing broadcast messaging among UAVs, according to various aspects of the present disclosure.

FIG. 3 is an illustration of an example associated with optimized broadcast message associated with optimizing broadcast messaging among UAVs, according to various aspects of the present disclosure.

FIGS. 4A-4D are illustrations of example situations associated with optimizing broadcast messaging among UAVs, according to various aspects of the present disclosure.

FIG. 5 is an illustration of example process associated with optimizing broadcast messaging among UAVs, according to various aspects of the present disclosure.

FIG. 6 is an illustration of example devices associated with optimizing broadcast messaging among UAVs, according to various aspects of the present disclosure.

### DETAILED DESCRIPTION

For the purposes of promoting an understanding of the principles of the present disclosure, reference will now be made to the aspects illustrated in the drawings, and specific language may be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one aspect may be combined with the features, components, and/or steps described with respect to other aspects of the present disclosure. For the sake of brevity, however, the numerous iterations of these combinations may not be described separately. For simplicity, in some instances the same reference numbers are used throughout the drawings to refer to the same or like parts.

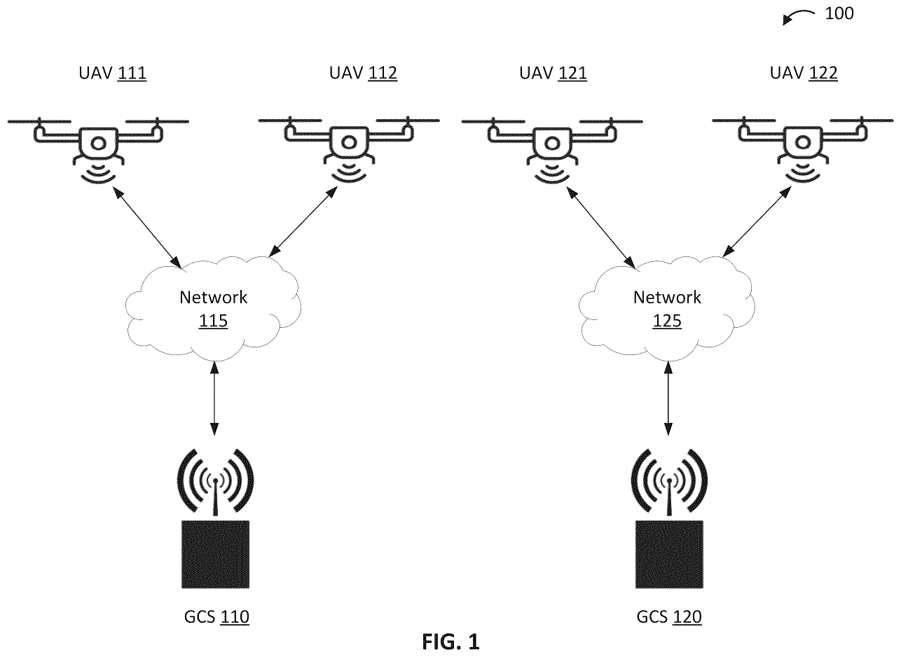

FIG. 1 is an illustration of an example system 100 associated with optimizing broadcast messaging among UAVs, according to various aspects of the present disclosure. The system 100 includes first UAVs 111, 112 communicating with an associated first ground control station (GCS) 110, and second UAVs 121, 122 communicating with an associated second ground control station (GCS) 120. Although only four UAVs and two GCSs are depicted in FIG. 1, the present disclosure contemplates any amount of GCSs being associated with any amount of UAVs.

In some aspects, the first UAVs 111, 112 may communicate with the first GCS 110 via a first network 115 and the second UAVs 121, 122 may communicate with the second GCS 120 via a first network 125. The first network 115 and the second network 125 may be a single network or separate networks, and may include a radio frequency (RF) network utilizing a protocol such as, for example, a MAVLink protocol. In some aspects, the GCSs 110, 120 may respectively monitor and assist UAVs 111, 112, 121, 122 during flight.

In some aspects, each of the UAVs 111, 112, 121, 122 may also directly communicate with each other using one or more of various long-range communication technologies such as, for example, Worldwide Interoperability for Microwave Access (WIMAX), cellular, satellite, infrared, RF, Wi-Fi, and/or private session communication. As discussed in further detail below, the UAVs may communicate using broadcast messages and/or direct messages.

A UAV (e.g., UAV 111, 112, 121, 122) may be physically equipped with a fixed wing structure (like an airplane) and/or a rotary wing structure (like a helicopter). The UAV may include a processor communicatively coupled to an electronic memory and transceiver circuitry. The processor and/or memory may be pre-programmed with flight plans and may operate electronics associated with navigation, control, and communication in accordance with the flight plans. Such electronics may include one or more rotors, global positioning system (GPS) receivers, gyroscopes, accelerometers, and sensors (e.g., lidar, cameras, etc.) for mapping and sensing. The processor may manage the UAV's flight and operational behavior, ensuring stability, responsiveness, and safety, and may communicate relevant information regarding the same to an associated GCS.

A GCS (e.g., GCS 110, 120) may include its own processor coupled to an electronic memory and transceiver circuitry. The GCS may configure the UAV with flight plans. In some aspects, configuring the UAV with flight plans may include programming and/or storing the flight plans in the processor and/or the electronic memory of the UAV. The GCS may also include an interface (e.g., screen, input/output units, etc.) for a human operator to monitor and/or communicate with the UAV during flight operation. At any time, the GCS may take over operations of the UAV. In some aspects, the GCS may be in constant communication with the UAV via communication links such as, for example, RF links, satellite links, and/or cellular links. The GCS may receive and log data such as, for example, flight data, sensor data, communication data, and performance data associated with the UAV. In some aspects, the GCS may analyze logged data to determine issues and/or refine or modify operational procedures associated with the flight plan.

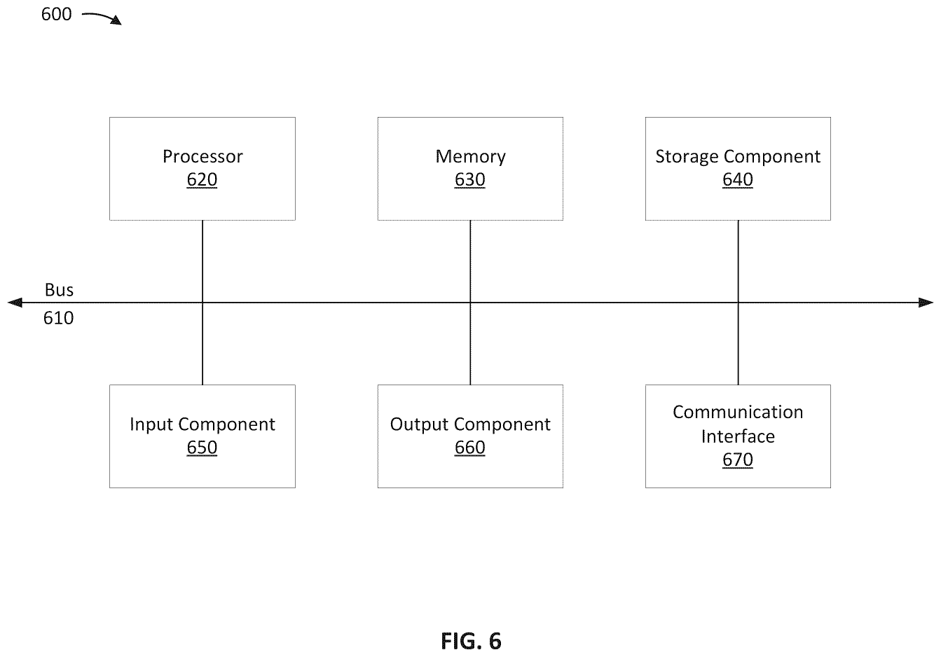

One or more devices (e.g., a UAV, a GCS, etc.) included in example 100 shown in FIG. 1 may further be associated with one or more components such as a controller/processor, a memory, a communication interface, or a combination thereof (e.g., FIG. 6). In some aspects, the one or more components may be separate and distinct from each other. Alternatively, in some aspects, the one or more components may be combined with another one of the one or more components. In some aspects, the one or more components may be local with respect to another one of the one or more components. Alternatively, in some aspects, the one or more components may be located remotely with respect to another one of the one or more components. Additionally, or alternatively, the one or more components may be implemented at least in part as software stored in a memory for execution by a processor. For example, a component (or a portion of a component) may be implemented as instructions or code stored in a non-transitory computer-readable medium and executable by a controller or a processor to perform the functions or operations of the component. Additionally, the one or more components may be configured to perform one or more functions described as being performed by another one of the one or more components.

As indicated above, FIG. 1 is provided as an example. Other examples may differ from what is described with regard to FIG. 1.

UAVs may have to follow certain rules and procedures during flight operation. Such rules and procedures may include, for example, rules associated with registering the UAVs with an appropriate aviation authority, following designated flight paths and staying within approved airspace, flying below a threshold height from the ground (e.g., 400 feet), and maintaining safe distance from buildings and physical structures, people, and also other UAVs (or aircrafts).

To maintain the safe distance from other UAVs in a shared airspace, a transmitting UAV may broadcast safety information that is to be received by other UAVs (e.g., receiving UAVs) flying within a threshold distance from the transmitting UAV. The safety information may include, for example, identification information to identify the transmitting UAV and a first GCS associated with the transmitting UAV, a location of the transmitting UAV, a speed of the transmitting UAV, an altitude of the transmitting UAV, and a timestamp to provide a time reference utilized by the transmitting UAV.

The safety information may be received by a receiving UAV that is flying within the threshold distance (e.g., 1 mile, 2 miles, 5 miles, etc.). Upon receiving the safety information, the receiving UAV may transmit (at least a portion of) the safety information to a second GCS associated with the receiving UAV. The second GCS may be the same as or different from the first GSC associated with the transmitting UAV. A human operator interfacing with the second GCS may interpret the safety information. Further, based at least in part on interpreting the safety information, the human operator may determine that the transmitting UAV is moving along a path that intersects a path being followed by a receiving UAV. In this case, the human operator may determine corrective action to avoid a potential collision between the transmitting UAV and the receiving UAV. In an example, the human operator may determine that the receiving UAV is to alter its flight operation to, for example, avoid the potential collision. In this case, the human operator may utilize the second GCS to transmit instructions that alter the flight plan to the receiving UAV to assist with avoiding the potential collision. In some cases, when the transmitting UAV transmits the safety information to the first GCS, a similar process may take place with respect to the transmitting UAV and the first GCS to assist the transmitting UAV in avoiding the potential collision.

It is time consuming for the safety information to be transmitted to a GCS (e.g., first GCS and/or second GCS), the safety information to be interpreted by the human operator, the human operator to determine the corrective action, the human operator to transmit the corrective action to the UAV (e.g., transmitting UAV and/or receiving (UAV), and for the UAV to implement the corrective action. These time consuming actions introduce a delay in the UAV implementing the corrective action. Additionally, the process may introduce errors due to involvement of a human operator. The introduction of the delay and/or errors introduced due to human involvement may result in the UAV's failure to avoid the collision.

Various aspects of systems, methods, and techniques discussed in the present disclosure provide optimized broadcast messaging among UAVs. In some aspects, the present disclosure contemplates a transmitting UAV broadcasting an optimized broadcast message that includes state information, in addition to safety information, to enable a receiving UAV to directly receive and interpret the state information without involvement of a GCS or a human operator. Further, the transmitting UAV and the receiving UAV may coordinate to take (corrective) action in real-time, all without involvement of a GCS or a human operator. The state information may include, for example, direction information to indicate current and/or intended movement of the transmitting UAV. Further, the state information may include, for example, traffic coordination information to enable the transmitting UAV and the receiving UAV to coordinate, in real-time, their movements in the airspace. In an example, the state information may indicate that the transmitting UAV is moving in a path that intersects a path being followed by a receiving UAV to enable both UAVs to avoid a possible collision. In another example, the state information may indicate that the transmitting UAV is moving to merge with the receiving UAVs following a given path. In yet another example, the state information may indicate that a minimum distance is to be maintained between the transmitting UAV and a receiving UAV. To coordinate in real-time, the receiving UAV may utilize first communication information included in the state information to establish a communication session to stay in communication with the transmitting UAV. The receiving UAV may also provide second communication information to enable the transmitting UAV to join the communication session and communicate with the receiving UAV.

In some cases, the state information may include information observed by the transmitting UAV during flight operation. For instance, the transmitting UAV may observe hazards such as, for example, strong winds, a thunderstorm, a flock of birds, an unknown UAV or aircraft, or a combination thereof. In this case, the transmitting UAV may autonomously reroute its flight plan to avoid the observed hazard, and may transmit the state information to the receiving UAV to indicate the observed hazard. As a result, the transmitting UAV may enable the receiving UAV to reroute its own flight plan and to avoid the observed hazard as well.

In this way, by optimizing the broadcast message to include the state information, the present disclosure may enable the transmitting UAV and the receiving UAV to coordinate and take corrective action autonomously without involvement of a GCS or a human operator. The optimized broadcast message enhances situational awareness among UAVs sharing the airspace and may assist the transmitting UAV and the receiving UAV to achieve intended movement while avoiding, for example, collisions and/or hazards. As a result, the present disclosure may mitigate effects of UAVs encountering collisions and/or hazards, thereby enabling efficient utilization of UAV resources and/or GCS resources (e.g., management resources, memory resources, computational/processing resources, power consumption resources, system bandwidth, network resources, etc.) while avoiding unnecessary utilization of such resources to address issues faced after UAVs collide or meet with the hazards.

In some aspects, a UAV may determine, based at least in part on utilizing an onboard sensor, state information associated with movement of the transmitting UAV and a receiving UAV operating in the airspace; broadcast, to the receiving UAV and based at least in part on determining the state information, an optimized broadcast message including the state information; directly communicate, with the receiving UAV, coordination information to coordinate real-time movement of the transmitting UAV and the receiving UAV; and effect movement of the transmitting UAV in the airspace in relation to movement of the receiving UAV in the airspace.

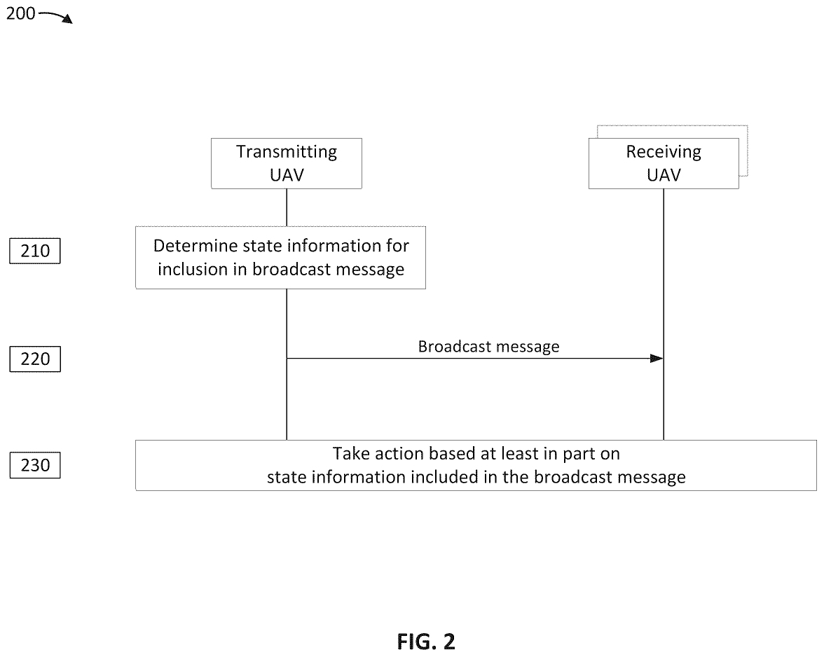

FIG. 2 is an illustration of an example flow 200 associated with optimizing broadcast messaging among UAVs, according to various aspects of the present disclosure. The example flow 200 may include a transmitting UAV (e.g., UAV 111, 112, 121, 122) and one or more receiving UAVs (e.g., 111, 112, 121, 122). In some aspects, the transmitting UAV and/or the receiving UAV may utilize respective processors and/or memories to execute the example flow 200. As discussed previously, optimizing the broadcast messaging may include determining and including state information in broadcast messages to be transmitted by the transmitting UAV. In some aspects, the transmitting UAV may transmit the broadcast message periodically (e.g., every 250 milliseconds, every 500 milliseconds, every 1 second, every 5 seconds, every 10 seconds, every 30 seconds, every 60 seconds, etc.) at a predetermined frequency (e.g., 1 KHz).

In some aspects, the transmitting UAV may be operating based at least in part on a flight plan pre-programmed by a first GCS (e.g., GCS 110) associated with the transmitting UAV. During flight operation, as shown by reference numeral 210, the transmitting UAV may determine the state information for inclusion in the broadcast message. The transmitting UAV may determine the state information in various ways in different situations.

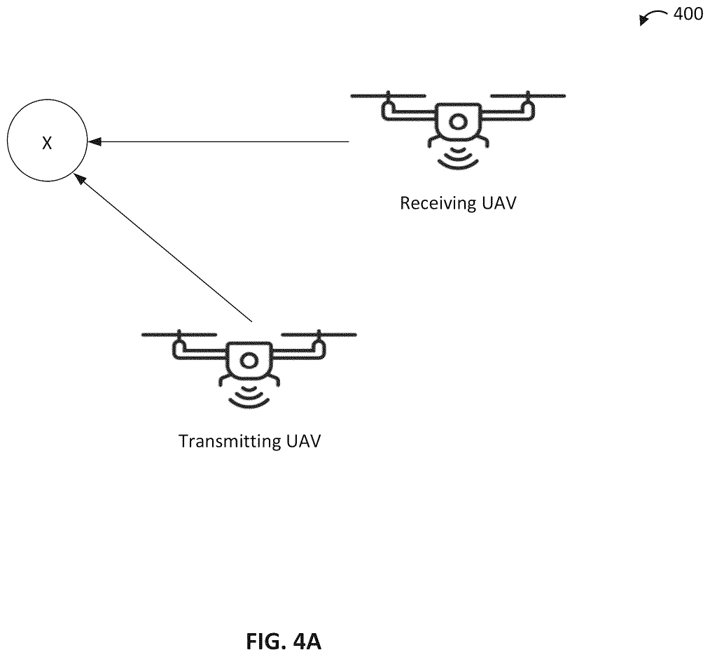

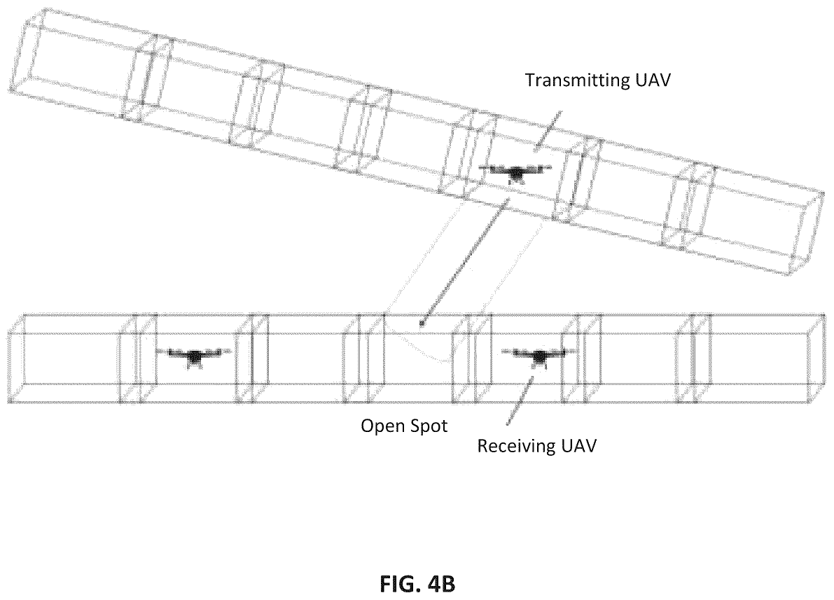

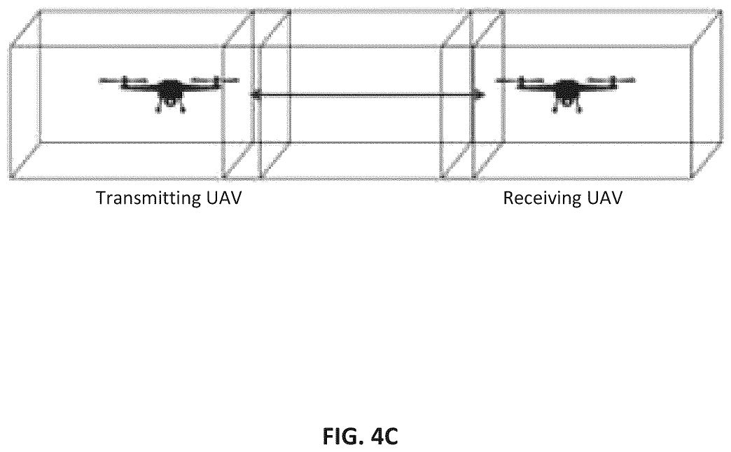

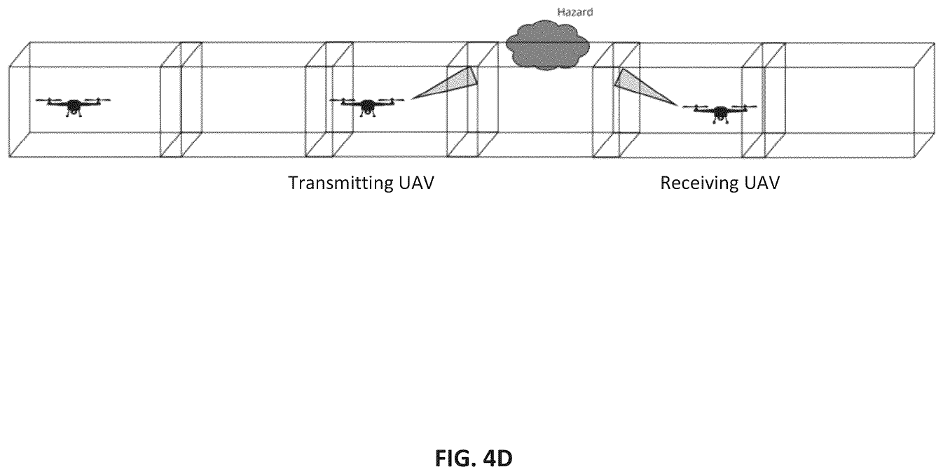

In an example, the transmitting UAV may determine the state information based at least in part on determining that the transmitting UAV moving in a path that intersects a path being followed by a receiving UAV. To determine the state information, during flight operation, the transmitting UAV may utilize onboard sensors (e.g., lidar, cameras, etc.) to sense characteristics of the surrounding airspace. For instance, the transmitting UAV may utilize the onboard sensors to determine that another UAV (e.g., receiving UAV) is operating within a threshold distance from the transmitting UAV. Further, the transmitting UAV may utilize the onboard sensors to constantly track movement of the receiving UAV within the threshold distance. Based at least in part on the sensing and/or tracking, as shown in FIG. 4A, the transmitting UAV may determine that the transmitting UAV and the receiving UAV are moving such that a potential collision may occur at location X.

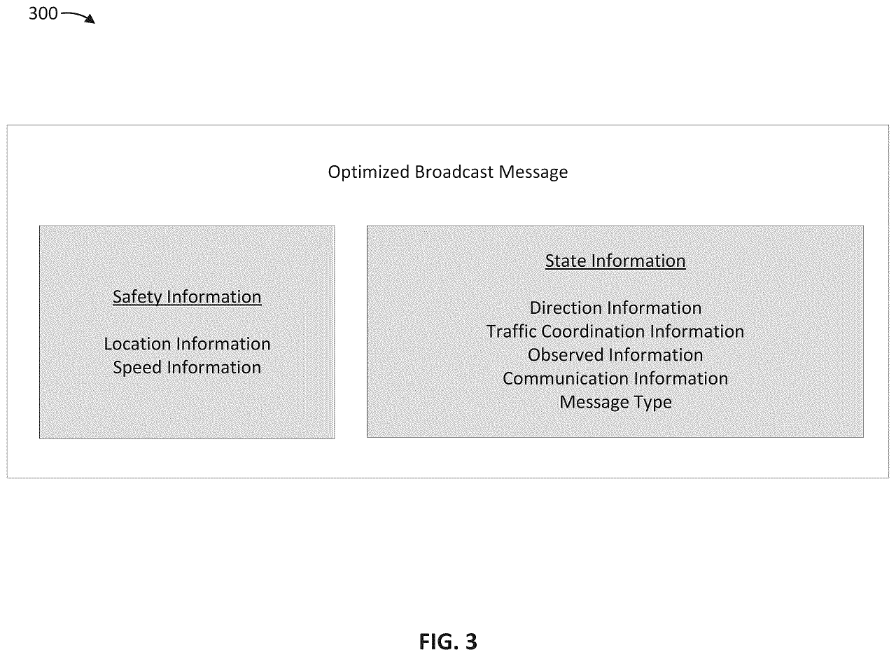

In this case, the transmitting UAV may determine and transmit the state information included in an optimized broadcast message shown in FIG. 3. The state information may inform the receiving UAV of the determination that the transmitting UAV and the receiving UAV are moving such that a potential collision may occur at location X. In some aspects, the state information may indicate the location X and an amount of time within which the potential collision may occur. The transmitting UAV may calculate this information based at least in part on determining a speed of the receiving UAV, the speed being determined based at least in part on tracking the receiving UAV.

In some aspects, the state information may be sufficient because, for example, the receiving UAV may yield to avoid the collision based at least in part on receiving the optimized broadcast message. In some aspects, a communication session may be established between the transmitting UAV and the receiving UAV to facilitate direct communication. For instance, based at least in part on receiving the state information in the optimized broadcast message, the receiving UAV may directly communicate with the transmitting UAV. To do so, the receiving UAV may utilize communication information included in the state information. For instance, the communication information may include an internet protocol (IP) address and/or a port associated with the transmitting UAV to enable the receiving UAV to communicate with the transmitting UAV.

In some aspects, the transmitting UAV and the receiving UAV may directly communicate coordination information to coordinate avoidance of the potential collision. For instance, the receiving UAV may indicate that the receiving UAV may yield to the transmitting UAV by, for example, slowing down the speed of the receiving UAV, or increasing the speed of the receiving UAV, or changing a direction of movement of the receiving UAV, or a combination thereof, such that the potential collision may be avoided. In another example, the receiving UAV may request the transmitting UAV to yield to the receiving UAV. In this case, the transmitting UAV may yield to the receiving UAV by, for example, slowing down the speed of the transmitting UAV, or increasing the speed of the transmitting UAV, or changing a direction of movement of the transmitting UAV, or a combination thereof, such that the potential collision may be avoided. In this way, by communicating coordination information, the transmitting UAV and the receiving UAV may avoid the collision.

In another example, the transmitting UAV may determine the state information based at least in part on determining that the transmitting UAV is to merge with one or more receiving UAVs moving along a given path. To determine the state information, during flight operation, the transmitting UAV may utilize the onboard sensors to determine that one or more UAVs (e.g., receiving UAV) within the threshold distance from the transmitting UAV is moving along the given path. Further, the transmitting UAV may utilize the onboard sensors to constantly track movement of the one or more receiving UAVs. Based at least in part on the sensing and/or tracking, as shown in FIG. 4B, the transmitting UAV may determine an open spot in the given path where the transmitting UAV is to merge.

In this case, the transmitting UAV may transmit the state information included in the optimized broadcast message shown in FIG. 3. The state information may enable real-time traffic conflict management between the transmitting UAV and the one or more receiving UAVs. For instance, the state information may request a receiving UAV near the open spot (e.g., receiving UAV moving into the spot) to yield and allow the transmitting UAV to move into the open spot. In some aspects, the state information may indicate a location of the open spot and other information (e.g., communication information associated with the transmitting UAV, timing information associated with merging into the open spot, etc.) to negotiate the merger. The transmitting UAV may calculate this information based at least in part on determining a speed of the one or more receiving UAVs, the speed being determined based at least in part on tracking movement of the one or more receiving UAVs along the given path.

Based at least in part on receiving the state information in the optimized broadcast message, the receiving UAV may directly communicate with the transmitting UAV to negotiate the merger. In some aspects, a communication session may be established between the transmitting UAV and the receiving UAV to facilitate direct communication. For instance, based at least in part on receiving the state information in the optimized broadcast message, the receiving UAV may initiate the communication session to directly communicate with the transmitting UAV. To do so, the receiving UAV may utilize the communication information included in the state information. The communication information may include an internet protocol (IP) address and/or a port associated with the transmitting UAV to enable the receiving UAV to initiate communication with the transmitting UAV.

During the communication, the receiving UAV may indicate that the receiving UAV may yield to the transmitting UAV by, for example, suspending or slowing down its movement towards the slot such that the transmitting UAV may enter the spot and merge in the given path. In some aspects, the receiving UAV may suspend its movement by hovering in its current location. In this case, the transmitting UAV may merge by entering the open spot. Further, the transmitting UAV may continue along the path at the speed determined based on the tracking of the one or more receiving UAVs. In some aspects, the transmitting UAV may communicate with the receiving UAV to confirm parameters (e.g., speed, direction of movement, distance to maintain between UAVs, etc.) associated with moving along the given path. In this way, the transmitting UAV may merge with the one or more receiving UAVs and move along the given path.

In some aspects, UAVs moving along the given path may be required to maintain a threshold amount of distance (e.g., number of spots) therebetween. For instance, a UAV moving along the given path may be required to maintain a distance of, for example, two spots between a preceding UAV and a following UAV (see FIG. 4B). In this case, when the receiving UAV suspends or slows down its movement towards the spot to allow the transmitting UAV to merge, the receiving UAV may transmit a message requesting the following UAV to also suspend or slow down its movement along the path to maintain the distance.

In yet another example, the transmitting UAV may determine the state information based at least in part on determining that a minimum distance is to be maintained between the transmitting UAV and other UAVs. To determine the state information, during flight operation, the transmitting UAV may utilize the onboard sensors to determine that one or more UAVs (e.g., receiving UAV) within the threshold distance from the transmitting UAV is either stationary or moving along a given path as the transmitting UAV. Further, the transmitting UAV may utilize the onboard sensors to constantly track movement of the one or more receiving UAVs. Based at least in part on the sensing and/or tracking, as shown in FIG. 4C, the transmitting UAV may determine that a minimum distance is to be maintained between the transmitting UAV and a receiving UAV.

In this case, the transmitting UAV may determine and transmit the state information included in the optimized broadcast message shown in FIG. 3. The state information may enable real-time traffic conflict management between the transmitting UAV and the one or more receiving UAVs. For instance, the state information may request a receiving UAV to maintain a minimum distance between the transmitting UAV and the receiving UAV. In an example, the state information may indicate an amount of the minimum distance (e.g., 10 feet, 15 feet, etc.). In another example, the state information may indicate an amount of open spots (e.g., 1 spot, 2 spots, etc.). In some aspects, the minimum distance may be part of the pre-programmed flight plan to be followed (in all directions) by the transmitting UAV. In some aspects, as shown in FIG. 4C, the minimum distance may be a parameter associated with a given path followed by the transmitting UAV and the (preceding and/or following) receiving UAV. In some aspects, the minimum distance may change during flight operation of the UAVs.

The transmitting UAV may utilize the onboard sensors to measure a distance between the transmitting UAV and the receiving UAV, and may compare the measured distance to the minimum distance. The transmitting UAV may then selectively request the receiving UAV to maintain the minimum distance based at least in part on a result of the comparison. For instance, when the transmitting UAV determines that the measured distance is smaller than the minimum distance, the transmitting UAV may include the request in the state information. Alternatively, when the transmitting UAV determines that the measured distance is greater than or equal to the minimum distance, the transmitting UAV may refrain from including the request in the state information.

Based at least in part on receiving the state information in the optimized broadcast message, the receiving UAV may directly communicate with the transmitting UAV to negotiate maintenance of the minimum distance. In some aspects, a communication session may be established between the transmitting UAV and the receiving UAV to facilitate the direct communication. For instance, based at least in part on receiving the state information in the optimized broadcast message, the receiving UAV may initiate the communication session to directly communicate with the transmitting UAV. To do so, the receiving UAV may utilize the communication information included in the state information. The communication information may include an internet protocol (IP) address and/or a port associated with the transmitting UAV to enable the receiving UAV to initiate communication with the transmitting UAV.

During the communication, the receiving UAV may indicate that the receiving UAV has received the state information and that, to maintain the minimum distance, the receiving UAV is, for example, suspending, speeding up, or slowing down its current movement. Alternatively, the receiving UAV may indicate that the receiving UAV has received the state information and may request the transmitting UAV to maintain the minimum distance by, for example, suspending, speeding up, or slowing down current movement of the transmitting UAV. In some aspects, a UAV (e.g., transmitting UAV or receiving UAV) may suspend its movement by hovering in its current location.

In some aspects, when the transmitting UAV and/or the receiving UAV suspends, speeds up, or slows down its movement to maintain the minimum distance, the transmitting UAV and/or the receiving UAV may transmit a message requesting at least another UAV to also suspend, speed up, or slow down its movement to maintain a respective minimum distance between (i) the transmitting UAV and/or the receiving UAV and (ii) the other UAV. In this way, the transmitting UAV and the receiving UAV may maintain the minimum distance therebetween and other UAVs.

In yet another example, the transmitting UAV may determine the state information based at least in part on determining and/or detecting presence of features in the airspace. Such features may include types of hazards such as, for example, ominous weather, non-conforming or unknown aircrafts or vehicles (manned or unmanned), and/or non-conforming objects. Ominous weather may include severe conditions including a windstorm, hail storm, tornado, snowstorm, heavy winds, heavy rainfall, or a combination thereof. Non-conforming or unknown aircrafts may include aircrafts failing to follow regulations associated with occupying the airspace. Non-confirming objects may include birds, etc.

To determine the state information, during flight operation, the transmitting UAV may utilize the onboard sensors to determine that a hazard has been observed. Further, the transmitting UAV may utilize the onboard sensors to constantly track movement of the observed hazard. Based at least in part on the sensing and/or tracking, as shown in FIG. 4D, the transmitting UAV may determine that the hazard may adversely affect the transmitting UAV and/or one or more receiving UAVs occupying the airspace.

In this case, the transmitting UAV may transmit the state information included in the optimized broadcast message shown in FIG. 3. The state information may enable real-time dissemination of information regarding the observed hazard to the one or more receiving UAVs. For instance, the state information may inform a receiving UAV regarding the observed hazard and may also request the receiving UAV to transmit at least a portion of the state information (e.g., information regarding the observed hazard) in its own broadcasted message to other UAVs. In some aspects, the state information may include information regarding the observed hazard such as, for example, a type of the observed hazard, a location and/or direction of movement of the observed hazard, a time associated with observing the hazard, etc. The transmitting UAV may utilize the onboard sensors to measure and/or determine such information regarding the observed hazard.

Based at least in part on receiving the state information in the optimized broadcast message, the receiving UAV may take real-time evasive action to mitigate effects of being adversely affected by the hazard. Further, based at least in part on receiving the state information, the receiving UAV may directly communicate with the transmitting UAV to coordinate evasive action. In some aspects, a communication session may be established between the transmitting UAV and the receiving UAV to facilitate the direct communication. For instance, based at least in part on receiving the state information in the optimized broadcast message, the receiving UAV may initiate the communication session to directly communicate with the transmitting UAV. To do so, the receiving UAV may utilize the communication information included in the state information. The communication information may include an internet protocol (IP) address and/or a port associated with the transmitting UAV to enable the receiving UAV to initiate communication with the transmitting UAV.

During the communication, the receiving UAV may indicate a type of evasive action being considered or being taken by the receiving UAV, which evasive action may include, for example, changing direction, suspending, speeding up, or slowing down its current movement. In some aspects, the coordination of the evasive action may assist in avoiding an inadvertent collision between the transmitting UAV and the receiving UAV while taking the evasive action.

The transmitting UAV and the receiving UAV may also transmit respective state information including the evasive action being considered or being taken to avoid inadvertent collision with other UAVs. In some aspects, when the transmitting UAV and/or the receiving UAV changes direction, suspends, speeds up, or slows down its movement to take evasive action, the transmitting UAV and/or the receiving UAV may transmit the optimized broadcast message requesting at least another UAV to also change direction, suspend, speed up, or slow down its movement to avoid inadvertent collisions among the UAVs. In this way, the transmitting UAV and the receiving UAV may deal with an observed hazard.

In some aspects, in the above examples, the state information included in the optimized broadcast message may also be sent to one or more GCSs. For instance, the transmitting UAV may transmit at least a portion of the state information to the GCS associated with the transmitting UAV and/or to the GCS associated with the receiving UAV. In some aspects, the GCS associated with the transmitting UAV and the GCS associated with the receiving UAV may be the same GCS. In some aspects, the GCS associated with the transmitting UAV and the GCS associated with the receiving UAV may be different GCSs.

By optimizing the broadcast message to include the state information, the present disclosure may enable the transmitting UAV and/or the receiving UAV to coordinate and take action autonomously without involvement of a GCS or a human operator. The optimized broadcast message enhances situational awareness among UAVs while operating in an airspace and may assist the transmitting UAV and/or the receiving UAV to achieve intended movement while avoiding, for example, collisions and/or hazards. As a result, the present disclosure may mitigate effects of UAVs encountering collisions and/or hazards, thereby enabling efficient utilization of UAV resources and/or GCS resources (e.g., management resources, memory resources, computational/processing resources, power consumption resources, system bandwidth, network resources, etc.).

As indicated above, FIGS. 2-4 are provided as an example. Other examples may differ from what is described with regard to FIGS. 2-4.

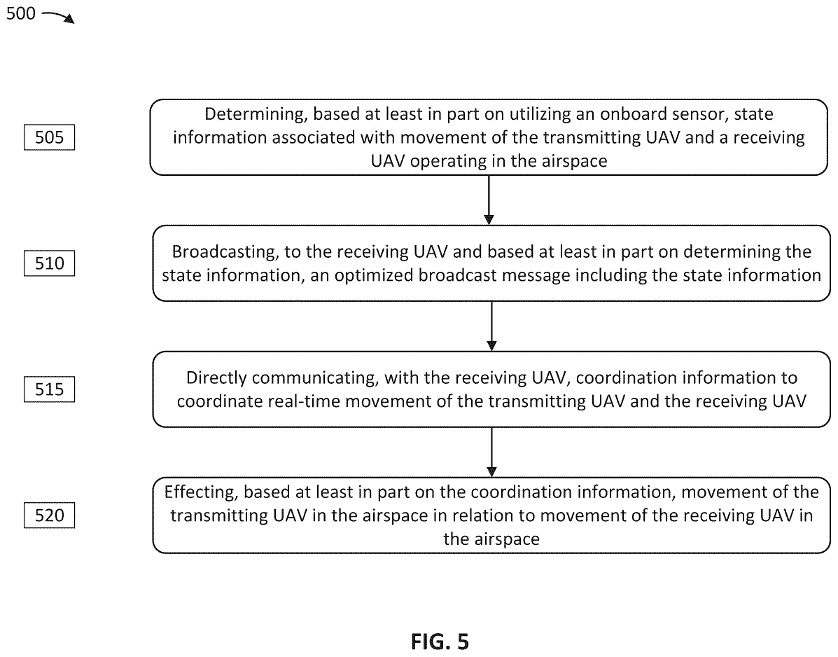

FIG. 5 is an illustration of an example process 500 associated with optimizing broadcast messaging among UAVs, according to various aspects of the present disclosure. In some aspects, the process 500 may be performed by respective memories and/or respective processors/controllers (e.g., processor 620) associated with one or more devices (e.g., transmitting UAV, receiving UAV, etc.) executing respective applications while operating in airspace and/or by a memory and/or a processor/controller (e.g., processor 620) associated with a GCS (e.g., GCS 110, GCS 120, etc.).

As shown by reference numeral 510, process 500 may include a transmitting UAV determining, based at least in part on utilizing an onboard sensor, state information associated with movement of the transmitting UAV and a receiving UAV operating in the airspace. For instance, the transmitting UAV may utilize the associated processor/controller to determine, based at least in part on utilizing an onboard sensor, state information associated with movement of the transmitting UAV and a receiving UAV operating in the airspace, as discussed elsewhere herein.

As shown by reference numeral 520, process 500 may include broadcasting, to the receiving UAV and based at least in part on determining the state information, an optimized broadcast message including the state information. For instance, the transmitting UAV may broadcast, to the receiving UAV and based at least in part on determining the state information, an optimized broadcast message including the state information, as discussed elsewhere herein.

As shown by reference numeral 530, process 500 may include directly communicating, with the receiving UAV, coordination information to coordinate real-time movement of the transmitting UAV and the receiving UAV. For instance, the transmitting UAV may utilize an associated communication interface (e.g., communication interface 670) with the associated processor/controller to directly communicate, with the receiving UAV, coordination information to coordinate real-time movement of the transmitting UAV and the receiving UAV, as discussed elsewhere herein.

As shown by reference numeral 540, process 500 may include effecting, based at least in part on the coordination information, movement of the transmitting UAV in the airspace in relation to movement of the receiving UAV in the airspace. For instance, the transmitting UAV may utilize the associated processor/controller to effect, based at least in part on the coordination information, movement of the transmitting UAV in the airspace in relation to movement of the receiving UAV in the airspace, as discussed elsewhere herein.

Process 500 may include additional aspects, such as any single aspect or any combination of aspects described below and/or in connection with one or more other processes described elsewhere herein.

In a first aspect, in process 500, determining the state information includes determining that the transmitting UAV is moving in a first path that intersects a second path being followed by the receiving UAV.

In a second aspect, alone or in combination with the first aspect, in process 500, determining the state information includes determining that the transmitting UAV is moving to merge with a path being followed by the receiving UAV.

In a third aspect, alone or in combination with the first through second aspects, in process 500, determining the state information includes determining that a minimum distance is to be maintained between the transmitting UAV and a receiving UAV in the airspace.

In a fourth aspect, alone or in combination with the first through third aspects, in process 500, determining the state information includes determining that the transmitting UAV has detected presence of a hazard in the airspace.

In a fifth aspect, alone or in combination with the first through fourth aspects, in process 500, directly communicating with the receiving UAV includes exchanging communication information with the receiving UAV.

In a sixth aspect, alone or in combination with the first through fifth aspects, in process 500, broadcasting the optimized broadcast message includes broadcasting the optimized broadcast message periodically.

Although FIG. 5 shows example blocks of the process, in some aspects, the process may include additional blocks, fewer blocks, different blocks, or differently arranged blocks than those depicted in FIG. 5. Additionally, or alternatively, two or more of the blocks of the process may be performed in parallel.

As indicated above, FIG. 5 is provided as an example. Other examples may differ from what is described with regard to FIG. 5.

FIG. 6 is an illustration of example devices 600, according to various aspects of the present disclosure. In some aspects, the example devices 600 may form part of or implement the systems, devices, environments, infrastructures, components, or the like described elsewhere herein (e.g., FIGS. 1-4) and may be used to perform the example processes described elsewhere herein. The example devices 600 may include a universal bus 610 communicatively coupling a processor 620, a memory 630, a storage component 640, an input component 650, an output component 660, and a communication interface 670.

Bus 610 may include a component that permits communication among multiple components of a device 600. Processor 620 may be implemented in hardware, firmware, and/or a combination of hardware and software. Processor 620 may take the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 620 may include one or more processors capable of being programmed to perform a function. Memory 630 may include a random access memory (RAM), a read only memory (ROM), and/or another type of dynamic or static storage device (e.g., a flash memory, a magnetic memory, and/or an optical memory) that stores information and/or instructions for use by processor 620.

Storage component 640 may store information and/or software related to the operation and use of a device 600. For example, storage component 640 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 650 may include a component that permits a device 600 to receive information, such as via user input (e.g., a touch screen display, a keyboard, a keypad, a mouse, a button, a switch, and/or a microphone). Additionally, or alternatively, input component 650 may include a component for determining location (e.g., a global positioning system (GPS) component) and/or a sensor (e.g., an accelerometer, a gyroscope, an actuator, another type of positional or environmental sensor, and/or the like). Output component 660 may include a component that provides output information from device 600 (via, for example, a display, a speaker, a haptic feedback component, an audio or visual indicator, and/or the like).

Communication interface 670 may include a transceiver-like component (e.g., a transceiver, a separate receiver, a separate transmitter, and/or the like) that enables a device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, and/or the like.

A device 600 may perform one or more processes described elsewhere herein. A device 600 may perform these processes based on processor 620 executing software instructions stored by a non-transitory computer-readable medium, such as memory 630 and/or storage component 640. As used herein, the term “computer-readable medium” may refer to a non-transitory memory device. A memory device may include memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described elsewhere herein. Additionally, or alternatively, hardware circuitry may be used in place of or in combination with software instructions to perform one or more processes described elsewhere herein. Thus, implementations described herein are not limited to any specific combination of hardware circuitry and software.

The quantity and arrangement of components shown in FIG. 6 are provided as an example. In practice, a device 600 may include additional components, fewer components, different components, or differently arranged components than those shown in FIG. 6. Additionally, or alternatively, a set of components (e.g., one or more components) of a device 600 may perform one or more functions described as being performed by another set of components of a device 600.

As indicated above, FIG. 6 is provided as an example. Other examples may differ from what is described with regard to FIG. 6.

Persons of ordinary skill in the art will appreciate that the aspects encompassed by the present disclosure are not limited to the particular exemplary aspects described herein. In that regard, although illustrative aspects have been shown and described, a wide range of modification, change, and substitution is contemplated in the foregoing disclosure. It is understood that such variations may be made to the aspects without departing from the scope of the present disclosure. Accordingly, it is appropriate that the appended claims be construed broadly and in a manner consistent with the present disclosure.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, or not equal to the threshold, among other examples, or combinations thereof.

It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting unmanned aerial vehicle (UAV) operating in airspace, the transmitting UAV comprising:
a processor; and
a memory communicatively coupled to the processor, the processor and the memory being configured to:
determine, based at least in part on utilizing an onboard sensor, state information associated with movement of the transmitting UAV and a receiving UAV operating in the airspace;
broadcast, to the receiving UAV and based at least in part on determining the state information, an optimized broadcast message including the state information;
directly communicate, with the receiving UAV, coordination information to coordinate real-time movement of the transmitting UAV and the receiving UAV; and
effect, based at least in part on the coordination information, movement of the transmitting UAV in the airspace in relation to movement of the receiving UAV in the airspace.

2. The transmitting UAV of claim 1, wherein, to determine the state information, the processor and the memory are configured to determine that the transmitting UAV is moving in a first path that intersects a second path being followed by the receiving UAV.

3. The transmitting UAV of claim 1, wherein, to determine the state information, the processor and the memory are configured to determine that the transmitting UAV is moving to merge with a path being followed by the receiving UAV.

4. The transmitting UAV of claim 1, wherein, to determine the state information, the processor and the memory are configured to determine that a minimum distance is to be maintained between the transmitting UAV and a receiving UAV in the airspace.

5. The transmitting UAV of claim 1, wherein, to determine the state information, the processor and the memory are configured to determine that the transmitting UAV has detected presence of a hazard in the airspace.

6. The transmitting UAV of claim 1, wherein to directly communicate with the receiving UAV, the processor and the memory are configured to exchange communication information with the receiving UAV.

7. The transmitting UAV of claim 1, wherein, to broadcast the optimized broadcast message, the processor and the memory are configured to broadcast the optimized broadcast message periodically.

8. A method in a transmitting unmanned aerial vehicle (UAV) operating in an airspace, the method comprising:
determining, based at least in part on utilizing an onboard sensor, state information associated with movement of the transmitting UAV and a receiving UAV operating in the airspace;
broadcasting, to the receiving UAV and based at least in part on determining the state information, an optimized broadcast message including the state information;
directly communicating, with the receiving UAV, coordination information to coordinate real-time movement of the transmitting UAV and the receiving UAV; and
effecting, based at least in part on the coordination information, movement of the transmitting UAV in the airspace in relation to movement of the receiving UAV in the airspace.

9. The method of claim 8, wherein determining the state information includes determining that the transmitting UAV is moving in a first path that intersects a second path being followed by the receiving UAV.

10. The method of claim 8, wherein determining the state information includes determining that the transmitting UAV is moving to merge with a path being followed by the receiving UAV.

11. The method of claim 8, wherein determining the state information includes determining that a minimum distance is to be maintained between the transmitting UAV and a receiving UAV in the airspace.

12. The method of claim 8, wherein determining the state information includes determining that the transmitting UAV has detected presence of a hazard in the airspace.

13. The method of claim 8, wherein directly communicating with the receiving UAV includes exchanging communication information with the receiving UAV.

14. The method of claim 8, wherein broadcasting the optimized broadcast message includes broadcasting the optimized broadcast message periodically.

15. A non-transitory computer-readable medium configured to store instructions, which when executed by a processor associated with a transmitting unmanned aerial vehicle (UAV) operating in airspace, configure the processor to:
determine, based at least in part on utilizing an onboard sensor, state information associated with movement of the transmitting UAV and a receiving UAV operating in the airspace;
broadcast, to the receiving UAV and based at least in part on determining the state information, an optimized broadcast message including the state information;
directly communicate, with the receiving UAV, coordination information to coordinate real-time movement of the transmitting UAV and the receiving UAV; and
effect, based at least in part on the coordination information, movement of the transmitting UAV in the airspace in relation to movement of the receiving UAV in the airspace.

16. The non-transitory computer-readable medium of claim 15, wherein, to determine the state information, the processor is configured to determine that the transmitting UAV is moving in a first path that intersects a second path being followed by the receiving UAV.

17. The non-transitory computer-readable medium of claim 15, wherein, to determine the state information, the processor is configured to determine that the transmitting UAV is moving to merge with a path being followed by the receiving UAV.

18. The non-transitory computer-readable medium of claim 15, wherein, to determine the state information, the processor is configured to determine that a minimum distance is to be maintained between the transmitting UAV and a receiving UAV in the airspace.

19. The non-transitory computer-readable medium of claim 15, wherein, to determine the state information, the processor is configured to determine that the transmitting UAV has detected presence of a hazard in the airspace.

20. The non-transitory computer-readable medium of claim 15, wherein to directly communicate with the receiving UAV, the processor is configured to exchange communication information with the receiving UAV.
